(19) United States
(12) Patent Application Publication
(10) Pub. No.: US 2025/0340742 A1
(43) Pub. Date: Nov. 6, 2025

(54) CORROSION INHIBITING COATING FOR METAL SUBSTRATES COMPRISING A BRITTLE ALUMINUM ALLOY AND A BINDER

(71) Applicant: The Patent Well LLC, Fort Worth, TX (US)

(72) Inventors: Ryan Merritt, Fort Worth, TX (US); Troy Wiegand, Fort Worth, TX (US); Josh Kennedy, Weatherford, TX (US); Ashley Archard, Arlington, TX (US)

(21) Appl. No.: 19/196,079

(22) Filed: May 1, 2025

Related U.S. Application Data
(60) Provisional application No. 63/642,223, filed on May 3, 2024.

(51) Int. Cl. C09D 5/10; C09D 7/40; C09D 7/62

(52) U.S. Cl. CPC C09D 5/103; C09D 7/62; C09D 7/69

(57) ABSTRACT

A corrosion inhibiting coating composition for a metal substrate, the coating composition comprises a film forming binder and powdered aluminum alloy particles. The aluminum alloy includes silicon in the amount of 1% to 30% by weight as well as one or more elements, selected from a first group, which comprises an embrittlement enhancing element and/or an electrochemical anodic enhancing element.

### CROSS-REFERENCE TO RELATED APPLICATION

This application claims the benefit of copending U.S. Provisional Patent Application No. 63/642,223 filed May 3, 2024, which is hereby incorporated.

### BACKGROUND OF THE INVENTION

### Field of the Invention

Coatings including corrosion inhibiting coatings for metal substrates.

### Description of the Related Art

Paints and other coatings are often applied to metallic substrates to inhibit corrosion of the substrates and to otherwise protect them from degradation.

Such paints and other coatings sometimes contain metallic particles such as aluminum or aluminum alloy particles, magnesium or zinc particles, the particles designed to help prevent, by acting as a sacrificial anode, galvanic corrosion of the metallic substrate.

Aluminum alloy particles have been used in corrosion inhibiting compounds, which aluminum alloy particles sometimes contain up to about 5 to 6% non-aluminum elements or ingredients.

### SUMMARY AND DETAILS OF THE INVENTION

U.S. Pat. No. 11,739,395 (incorporated herein by reference) issued recently and discloses an aluminum alloy containing embrittling elements selected from the group consisting of silicon in the amount of 1 to 30% by weight and/or germanium. This patent claims a method for creating an aluminum powder comprising blending and melting aluminum with an embrittling element or a combination of embrittling elements. The alloy is cooled, cut into smaller pieces, which are crushed. The crushed pieces are pulverized and milled into a size less than 200 microns (for reference, a human hair is about 50 microns in diameter).

The '395 patent also discloses the use of activators consisting of Tin, Indium, Gallium and Bismuth, mixed in with the aluminum and the embrittling elements. These alloys enable the control of narrow particle size distributions d10 and d90 less than or equal to 50% smaller or greater than d50, respectively (i.e., d10-5 microns, d50 equals 10 microns and d90 equals 15 microns) as well as powder sizes at least as small as 4 microns in diameter.

It is an object of this invention to provide for corrosion inhibiting coatings for metal substrates that use one or more of the alloys disclosed in the '395 patent. Collectively these alloys will be referred to as “high em” (high embrittlement) aluminum alloys.

These include at least the following Al alloys: Aluminum alloys that are both brittle (elongation of less than 1%), and electroactive (in some embodiments electrical potential less than 0.900 volts versus saturated calomel electrode, efficiency greater than 70% and high current density); Aluminum alloys with 1-30% (preferably 10-30% weight Silicon); alloys with these percentages of Silicon and either germanium or gallium as additional embrittlement elements; alloys of these percentages of silicon along with less than 1% each, of one or more of the following activating elements (making alloy more anodic): Indium, Gallium, Tin and Bismuth.

Powdered particles of any of the foregoing alloys are considered to be particles having their longest diameter of 300 microns or less, and a preferred embodiment 200 microns or less, in yet another preferred embodiment between 10 nanometers and 30 microns.

In some embodiments of the Applicant's invention one or more high em powder particles are mixed in a binder to form a corrosion inhibiting coating on a metal substrate. In some embodiments of the Applicant's invention the corrosion inhibiting compounds are used on an aluminum alloy substrate that is part of an aircraft.

### A. Binders

The binders of Applicant's present invention may include one or a mixture of the following: curable organic or inorganic compositions, resins and resins with curing agents, polymers and the like.

The binders may be one part, with moisture/air or UV curing. The binders may be two parts, such as a resin and a curing agent (hardener) curing for example, via cross linking. The binders may be three parts.

Binders include all of the binders set forth in the claim set below. These are only a partial listing of binders that may be used with Applicant's high em powder particles.

Binders may also include grease, oils, wax, lubricants, sealants, adhesives, gels, elastomers, cold sprays and brush on binders.

In some embodiments the coating compositions may comprise 20-95% of the non-volatile weight of the film forming binder, 10-70% coated or uncoated powder particles and 0.0 to 40% corrosion inhibitors, all by weight. The powder may be placed in the binder in an uncoated condition or may be coated prior to mixing with the binder.

In addition to the high em aluminum powder whether coated or uncoated placed in the binder there may be other ingredients mixed into the binder/powder mix. These other ingredients may include at least corrosion inhibitors.

The corrosion inhibitors typically act upon the metal substrate, here, in some embodiments, an aluminum alloy substrate such as aluminum alloy as part of an aircraft. The corrosion inhibitors typically act independently of or synergistically with the aluminum powder to reduce the corrosion of the aluminum substrate.

At this point Applicant asks the reader to note the use of the word coating. It is sometimes used to describe the corrosion inhibiting coating applied to the aluminum substrate, that is to say, a corrosion inhibiting coating comprising at least a binder and high em aluminum alloy powder. Applicant also uses the word “coating” to describe a coating on the powder particle itself, that is created in a process of treating the powder prior to mixing the powder with the binder. Context should tell the reader when coating refers to the treatment of the aluminum powder or coating refers to the powder binder mix.

Applicant further asks the reader to note that the nature of the powder is an aluminum alloy and the nature of the preferred metal substrate to which the corrosion inhibiting coating is applied is also aluminum alloy. However, the nature of the powder is the specific aluminum alloys described as high em herein, whereas the metal substrate may be any aluminum alloy, such as those typically found in the construction of aircraft and parts of.

### B. Coatings on the High em Aluminum Alloy Particles

When the powders are coated they are coated to improve the galvanic corrosion protection of the metal substrate. That is to say, coatings on the high em aluminum powders set forth herein may, in some embodiments, improve their ability to protect the underlying metallic substrate from galvanic corrosion.

These coatings may include coatings that are semiconductive, such as metal oxides. These coatings may be coatings derived from acidic aqueous solutions including trivalent chromium. These coatings may include coatings derived from titanium zirconate salts or molybdate solutions. These coatings may be conversion coatings which passivate the surface of the aluminum alloy particles. These coatings will be set forth in more detail below and include the coatings set forth in the claims.

U.S. Pat. Nos. 8,277,688 and 9,243,150 (both incorporated herein by reference), describe a semi conducting coating that may be applied to aluminum alloy powders described therein. Applicant applies these coatings to the high em aluminum alloy powders disclosed herein. The coatings are derived from trivalent chromium compounds. The powder or ‘pigment’ coating is described as a corrosion inhibiting coating because it helps prevent the aluminum powder from corroding and thus no longer able to act as the sacrificial anode.

In some embodiments the semiconductive coating is derived from treating the powder in an acidic aqueous solution of from about 0.01 to 22 parts by weight of a trivalent chromium compound, from about 0.01 to 12 parts by weight of hexafluorozirconate, from about 0.01 to 12 parts by weight of at least one fluorocarbon selected from the group consisting of tetra fluoroborates, hexafluoro silicates, and hexafluoro titanates, from about 0.00 to 12 parts by weight of at least one divalent zinc compound.

In another example, the semi-conducting coating on the high em alloy may be derived from an acidic aqueous solution consisting essentially of from about 0.01 to 22 parts by weight of a trivalent chromium compound, from about 0.01 to 12 parts by weight of a hexafluorozirconate, from about 0.01 to 12 parts by weight of at least one fluorocarbon selected from the group consisting of tetrafluoroborates, hexafluoro silicates, and hexafluoro titanates.

In another example, the semi-conducting coating may be derived from an acidic aqueous solution consisting essentially of from about 0.01 to 22 parts by weight of a trivalent chromium compound, from about 0.01 to 12 parts by weight of a hexafluorozirconate, from about 0.01 to 12 parts by weight of at least one fluorocarbon selected from the group consisting of tetrafluoroborates, hexafluoro silicates, and hexafluoro titanates and from about 0.01 to 12 parts by weight of at least one divalent zinc compound.

In another example, the semi-conducting coating may be derived from an acidic aqueous solution consisting essentially of from about 0.01 to 22 parts by weight of a trivalent chromium compound, from about 0.01 to 12 parts by weight of a hexafluorozirconate, 0.01 to 12 parts by weight of at least one fluorocarbon selected from the group consisting of tetrafluoroborates, hexafluoro silicates, and hexafluoro titanates, from about 0.00 to 12 parts by weight of at least one divalent zinc compound, and from about 0.01 to 5 parts by weight of water soluble organic corrosion inhibitor.

In another example, the semi-conducting coating may be derived from an acidic aqueous solution consisting essentially of from about 0.01 to 22 parts by weight of a trivalent chromium compound, from about 0.01 to 12 parts by weight of a hexafluorozirconate, from about 0.00 to 12 parts by weight of at least one divalent zinc compound, effective amounts of at least one stabilizing compound selected from the group consisting of polyhydroxy compounds, carboxylic compounds and mixtures of the polyhydroxy and carboxylic compounds, and from about 0.00 to 5 parts by weight of water-soluble organic corrosion inhibitor.

For purposes of this application, whenever a range for a component specified herein is from 0.00 to some amount, this component is optional.

The powder coating composition may also be derived from, essentially of an acidic aqueous solution consisting essentially of from about 0.01 to 22 parts by weight of a trivalent chromium compound, from about 0.01 to 12 parts by weight of hexafluorozirconate, from about 0.01 to 12 parts by weight of at least one fluorocarbon selected from the group consisting of tetrafluoroborates, hexafluoro silicates, and hexafluoro titanates and from about 0.0 to 5 parts by weight of a water-soluble corrosion inhibitor.

The powder coatings described above are generally referred to as tri chromium (TCP or Tri chromium Passivation) based coatings. Initial testing with Si 20%, Tin 0.05% and Indium 0.02% by weight (remainder pure aluminum or about 99% pure) revealed that it received the TCP coating well, as compared to the prior art low Silicon Aluminum alloys (less than 5% Si).

Set forth below are semiconductive coatings for the high em aluminum alloy powders set forth herein that may be referred to as molybdate-based coatings. These coatings may be found in U.S. Ser. No. 17/655,298 incorporated herein by reference.

The molybdate solution is reactive to the alloy particles in an uncoated state.

The molybdate solution is aqueous and includes a molybdate and at least one of a permanganate and a hexafluorozirconate.

The molybdate, permanganate and hexafluorozirconate are selected from the group comprising: potassium molybdate, potassium permanganate and potassium hexafluorozirconate. Each of the molybdate, permanganate and hexafluorozirconate components present in the molybdate solution is typically present in the molar range from 0.001-0.50 moles per liter of the molybdate solution. The coating has a thickness of between 1 nanometer and 3 micron.

The molybdate solution is an aqueous solution and includes a pH adjuster and/or a buffer. The pH of the molybdate solution is typically adjusted to between 2 and 4 or between 9 and 11. The coating is typically free of one or more of: chromium and lithium.

A method of manufacturing the coated high em powder may include the steps of: mixing the molybdate or TCP solution; and, adding the metal particles to the mixed molybdate or TCP solution. The mixed solution is capable of receiving the metal particles immediately post mixing of said molybdate solution but the TCP may require time before use.

The method of coating may further include at least one of the following steps: cleaning the metal particles prior to adding said metal particles to the solution; agitating or stirring the mixture of metal particles and solution for a period of time; decanting off the solution; rinsing the wet coated particles; and drying the coated particles.

The steps of mixing the molybdate solution for use in the powder coating may comprise the steps of: providing a quantity of deionized water; adding in powder form components of the molybdate solution to the deionized water; and mixing the powder form components of the molybdate solution with the deionized water. The powder form components may be selected from the group comprising: potassium molybdate, potassium permanganate and potassium hexafluorozirconate.

The coatings set forth immediately above may be referred to as Molybdate based powder coatings.

In addition to the above, there are semi-conductive coatings on the aluminum particles derived from titanium zirconate salts. A chemical conversion coating on aluminum alloy (whose chemical composition is composed of Mg 2.2%- 2.8%, Si 0.25%, Cu 0.1%, Zn 0.1%, Mn 0.1%, Fe 0.4%, Cr 0.15%- 0.35% and balance of Al) was used as a solution to coat metal particles. The chemical conversion coating was prepared by using K2ZrF6 and K2TiF6 as the main salts, KMnO4 as the oxidant and NaF as the accelerant. The same is proposed by the Applicant for the High em powder. The results showed that the prepared conversion coating mainly consisted of AlF₃·3H₂O, Al₂O₃, MnO₂ and TiO₂, and exhibited good corrosion resistance.

The conversion treatment solution was composed of KMnO₄:2-4 g L-1, NaF: 0.1 g L-1, K₂ZrF₆:0.25-0.75 g L-1, K2TiF6:1-1.5 g L-1. The pH was about 2, the treatment temperature was in the range of 70-80° C. and the treatment time was about 5 min. The treatment solution was composed of NiSO₄·6H₂O: 1.2 g L-1, NaF: 0.6 g L-1, the treatment time was about 30 min and treatment temperature was room temperature. After the conversion treatment, the samples were treated in boiling water for about 30 min, then immersed in fluorosilane (FAS-17:2 g, isopropanol: 180 g, H₂O: 18 g) at room temperature for about 24 h. The samples were then dried in the oven at 120° C. for about 30 min. The treatment time and/or temperature may be extended for treatment of high em powder. See https://www.mdpi.com/2079-6412/8/11/397, incorporated herein by reference.

This conversion coating may be used on the high em powder.

### C. Corrosion Inhibitors for Mixing into the Binder/Powder Mix

Applicant requests the reader to note that corrosion inhibitors may be used in both the formulation for coating the power particles before the coated powder particles are placed in the binder and corrosion inhibitors may also be placed in the binder powder mix. The role of the former is to, primarily, slow the corrosion of the aluminum powder particles as they act as a sacrificial anode. The role of the latter is to protect the aluminum substrate surface. Below we will discuss the role of corrosion inhibitors for mixing into the binder/powder mix.

Any of the corrosion-resistant coatings may further comprise a corrosion inhibitor. The corrosion inhibitor may be ionic or organic.

The corrosion resistant coating may include at least one corrosion inhibitor selected from the group comprising: a lithium salt, an organic or inorganic lithium salt, lithium phosphate, lithium carbonate, at least one metal polycarboxylate, magnesium containing materials, magnesium metal particles, magnesium alloy, magnesium oxide, oxyaminophosphate salts of magnesium, magnesium carbonate and magnesium hydroxide, magnesium citrate, magnesium oxalate, zinc citrate, zinc oxalate, and a combination thereof. The corrosion inhibitor is lithium free in some embodiments. The corrosion inhibitor comprises, in some embodiments, lithium free synergistic combinations of metal oxalates, metal pirates, metal succinate, metal tartrates and metal adipate. Some of the foregoing may be found in U.S. Pat. No. 8,628,689, incorporated herein by reference, as well as U.S. Pat. No. 10,351,715, incorporated herein by reference.

The corrosion inhibitor may include a zinc salt of 2,5-dimercapto-1,3,4-thiadiazole (DMTD), wherein the zinc salt of DMTD is 2, 5-dimercapto-1,3,4-thiadiazole zinc salt (VII) and a lithium salt with a solubility in water in the range from 0.01 to 120 g/L at 20° C., selected from the group consisting of lithium carbonate, lithium phosphate, lithium bicarbonate, lithium tetraborate, and lithium oxalate. See Patent Cooperation Treat Application no. WO2023135326 incorporated herein by reference.

The corrosion inhibitor comprises in some embodiments, a combination of lithium phosphate with metal polycarboxylate compounds as set forth in U.S. Pat. No. 10,889,723 incorporated herein by reference.

The corrosion inhibitor may be an organic corrosion inhibitor selected from the group consisting of benzimidazole, benzothiazole, benzoxazole, diphenyl triazole, benzotriazole and tolylazole. These may be found in U.S. Pat. No. 9,243,150 incorporated herein by reference.

The corrosion Inhibitors may include zinc and magnesium phosphates individually or mixed up to 50% by weight of the final coating composition, with or without any of the polycarboxylates listed above or with or without any of the lithium salts listed above.

The following embodiments disclose the incorporation of carboxylate metal salts in chromium-free conversion coatings in the binder/powder mix for the purposes of increasing corrosion resistance. The compositions of the inhibitor salts are described as follows. Anions include the polycarboxylates chosen from linear and branched aliphatic molecules like oxalate, citrate, tartrate, succinate, malonate and adipate and the like. Cations include zinc, magnesium, manganese, calcium, strontium, zirconium, scandium, yttrium, lanthanum, and other lanthanides like cerium, praseodymium, neodymium, samarium, europium and gadolinium. The choice of anion and cation will influence water solubility as well as the reactivity with the other chemistries involved in the conversion coating solution and/or the metallic substrate.

The carboxylate metal salts are added to the chromium-free conversion-free conversion coating in amounts ranging from about 0.5 to 5.0 grams per liter and may be added individually or in combination with other inhibitors. Carboxylate inhibitors may be blended with other carboxylate inhibitors using the same cation. For example, but without limitation, zinc oxalate and zinc malonate may be blended, or they may be blended with different cations with the same or different anions. Another example, but without limitation, cerium oxalate and zinc oxalate or cerium oxalate and zinc malonate may be blended. Carboxylate inhibitors may also be combined with soluble inorganic salts with the same cation, such as zinc oxalate and zinc sulfate or they may be blended with different cations with different anions such as zinc oxalate and lithium phosphate.

Inhibitors may also be blended with different molar ratios to obtain the maximum synergistic performance. This may range, but without limitation, from relatively low concentrations of a few milligrams per liter to beyond the supersaturation point for the carboxylate inhibitor where no more can dissolve in solution.

These more specifically relate to synergistic metal polycarboxylate combinations and to methods of treating metal to improve the metal's corrosion resistance. The method includes applying to the surface of metal, a chromium-free conversion coating which comprises an effective amount of a synergistic mixture of metal carboxylates. More specifically, but without limitation, a synergistic blend of corrosion inhibitors, consisting of at least two different metal carboxylates, such as polycarboxylics chosen from linear and branched aliphatic molecules like oxalate, succinate, and adipate, and aromatic molecules like phthalate, mellitate and trimellitate and the like. These are specific examples of some molecules. There are many other polycarboxylic acids which can be used for preparing the synergistic combination.

The cations of the metal carboxylates are identified in the Periodic Table and include, for example, but without limitation, elements chosen from: Group Ia—Lithium, potassium and sodium; Group IIa—Magnesium, calcium, strontium, and barium; Group IIIb—Scandium, yttrium, lanthanum and the other lanthanides; Group IVb—Titanium and zirconium; Group Vb—Vanadium and niobium; Group VIb—Chromium and molybdenum; Group VIIb—Manganese; Group VIII—Iron, cobalt and nickel; Group Ib—Copper; Group IIb—Zinc; Group IIIa—Aluminum, and Group Va—Bismuth. See U.S. Patent Application Publication no. 2023/0136068 incorporated herein by reference.

### D. Other Ingredients for the Binder Powder Mix

Surfactants, wetting agents, defoamers or adhesion promoters may be used as desired. When the binder is a resin and a curing agent, an accelerant may be used.

### E. Loading of Binder/Powder Mix

The binder/powder mix may comprise by non-volatile weight of the film forming composition: 20-95% binder; 10-70% coated particles; and 0.0-40% corrosion inhibitor. Optionally, 0.0 to 5.0 parts and preferably 0.1 to 1.5 parts of at least one wetting agent or surfactant and from about 0.0 to 5.0 parts of solvent such as water or an organic solvent.

### F. Uses of the Novel Corrosion Inhibiting Compound

Use of the novel corrosion inhibiting coating compositions described herein.

The novel corrosion inhibiting coatings may be used on aluminum alloys whose surface may be pretreated before application of the coating. For example, the aluminum alloy substrate may be pretreated with conversion coatings known in the art, may be anodized or may be treated to increase the adhesion of the binder to the aluminum alloy surface.

The novel corrosion inhibiting coatings may be used as a primer or paint on the exterior or interior of an aluminum or aluminum alloy surface or part of an aircraft.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention.

What is claimed is:

1. A corrosion inhibiting coating composition for a metal substrate, the coating composition comprising:
a film forming binder; and
powdered aluminum alloy particles the aluminum alloy having silicon in the amount of 1% to 30% by weight as well as one or more elements, selected from a first group, the first group comprising: an embrittlement enhancing element and/or an electrochemical anodic enhancing element.

2. The coating composition of claim 1 wherein: the silicon in the aluminum alloy is 10% to 30% by weight and the first group comprises 0.01% to 0.50% tin and 0.005%, to 0.05% Indium by weight.

3. The coating composition of claim 1 wherein: first group consists of tin, Indium, germanium, gallium or magnesium each of the selected element or elements in the amount of 0.01% to0.50% by weight.

4. The coating composition of claim 1 wherein the binder includes at least one of the following: a curable organic binder; a curable inorganic binder; a resin; and/or a polymer binder.

5. The coating composition of claim 1 wherein the binder includes:
a film-forming resin selected from the group consisting of epoxy resins, polyesters, polyacrylates, polyurethanes, polyethers, polyaspartic esters, isocyanates, mercapto-functional resins, amine-functional resins, amide-functional resins, imide-functional resin, acetoacetate resins, functional fluorinated resins, alkyd resins, and mixtures thereof.

6. The coating composition of claim 5 further including: a curing agent, wherein the curing agent is from a group comprising hydroxy-functional resins including isocyanates and isocyanurates.

7. The coating composition of claim 1 wherein:
the film forming binder for the coating composition is selected from the group consisting of polyacrylates, polyurethanes, polyimides, polymers derived from epoxies, polymers derived from isocyanates, and the uncured pre-polymers or monomers of said polymers; or
the film-forming binder is selected from the group consisting of inorganic polymers derived from silanes, siloxanes, and silicones; or
the binder is a resin and a curing agent.

8. The coating composition claim 1, wherein the particles are between 1-200 microns, longest dimensions.

9. The coating compositions of claim 8 wherein half of the particles are between 5 and 20 microns, and/or wherein 10% of the particles are smaller than 5 microns, 50% smaller than 10 microns and 90% smaller than 15 microns.

10. The coating compositions of claim 1 wherein the particles are:
coated with a semi-conductive coating and/or a metal oxide; or
passivated with a conversion coating.

11. The coating composition of claim 1 wherein the particles are treated with a salt solution of titanium and zirconium salts.

12. The coating composition of claim 1 wherein the particles are coated with a semi-conducting corrosion inhibiting coating derived from a solution consisting essentially of an acidic aqueous solution of from about 0.01 to 22 parts of a trivalent chromium compound, from about 0.01 to 12 parts of hexafluorozirconate, from about 0.01 to 12 parts of at least one fluorocarbon selected from the group consisting of tetra fluoroborates, hexafluoro silicates, and hexafluoro titanates, from about 0.00 to 12 parts of at least one divalent zinc compound.

13. The coating composition of claim 1 wherein the particles are coated with a semi- conducting corrosion inhibiting coating derived from a solution consisting essentially of an acidic aqueous solution of from about 0.01 to 22 parts of a trivalent chromium compound, from about 0.01 to 12 parts of hexafluorozirconate, from about 0.01 to 12 parts of at least one fluorocarbon selected from the group consisting of tetra fluoroborates, hexafluoro silicates, and hexafluoro titanates, from about 0.00 to 12 parts of at least one divalent zinc compound and further including up to 5 parts by weight of a corrosion inhibitor.

14. The coating compositions of claim 1 wherein the particles are coated:
with a semiconductive coating derived from a molybdate solution; or
from an aqueous solution consisting essentially of trivalent chromium compounds, hexafluoro zirconates, and at least one fluorocarbon selected from the group consisting of tetrafluoroborates, hexafluoro silicates, and hexafluoro titanates.

15. The coating composition of claim 1 wherein the particles are coated with a coating derived from a corrosion-resistant aqueous composition having a pH ranging from about 2.8-4.0 at temperatures ranging from about 120 F to 200 F degrees, wherein the particle coating composition consists essentially of, in parts by weight per liter of water, from about 20 to 70 parts of potassium hexafluorozirconate, 15 to 92 parts of chromium sulfate (basic), and from 0.0 parts to about 1.5 parts of potassium tetrafluoroborate.

16. The coating composition of claim 4 further including a corrosion inhibitor.

17. The coating composition of claim 16 wherein the corrosion inhibitor is an inorganic or an organic compound.

18. The coating compositions of claim 16 wherein the corrosion inhibitor is a lithium salt, wherein the lithium salt is selected from inorganic and organic lithium salts that have a solubility constant in water at 25° C. in the range of 1×10⁻¹¹ to 5×10⁻².

19. The coating composition of claim 16 wherein the corrosion inhibitor includes a zinc salt of 2,5-dimercapto-1,3,4-thiadiazole (DMTD), wherein the zinc salt of DMTD is 2, 5-dimercapto-1,3,4-thiadiazole zinc salt (VII) and a lithium salt with a solubility in water in the range from 0.01 to 120 g/L at 20° C., selected from the group consisting of lithium carbonate, lithium phosphate, lithium bicarbonate, lithium tetraborate, and lithium oxalate.

20. The coating composition of claim 16 wherein the corrosion inhibitor comprises:
an effective amount of a synergistic mixture of metal polycarboxylates; or
a combination of lithium phosphate with metal polycarboxylate compounds; or
an organic corrosion inhibitor selected from the group consisting of benzimidazole, benzothiazole, benzoxazole, diphenyl triazole, benzotriazole and tolylazole.

21. A corrosion inhibiting coating composition for a metal substrate, the coating composition comprising:
a film forming binder;
a corrosion inhibitor, wherein the corrosion inhibitor is an inorganic or an organic compound; and
powdered aluminum alloy particles the aluminum alloy having silicon in the amount of 1% to 30% by weight as well as one or more elements, selected from a first group, the first group comprising: an embrittlement enhancing element and/or an electrochemical anodic enhancing element;
wherein the particles are coated with a semi-conductive coating and/or a metal oxide, or passivated with a conversion coating;
wherein the binder includes at least one of the following: a curable organic binder, a curable inorganic binder, a resin, and/or a polymer; and
wherein the corrosion inhibitor is an inorganic or an organic compound.

22. The corrosion inhibiting coating composition of claim 21 wherein first group consists of tin, Indium, germanium, gallium or magnesium each of the selected element or elements in the amount of 0.01% to 0.50% by weight.

23. The corrosion inhibiting coating composition of claim 21 wherein the binder is a resin selected from the group consisting of epoxy resins, polyesters, polyacrylates, polyurethanes, polyethers, polyaspartic esters, isocyanates, mercapto-functional resins, amine-functional resins, amide-functional resins, imide-functional resin, acetoacetate resins, functional fluorinated resins, alkyd resins, and mixtures thereof.

24. The corrosion inhibiting coating composition of claim 23 further including a curing agent.

25. The corrosion inhibiting coating composition of claim 24, wherein the curing agent is from a group comprising hydroxy-functional resins including isocyanates and isocyanurates.
